(19) United States
(12) Patent Application Publication
(10) Pub. No.: US 2012/0285337 A1
(43) Pub. Date: Nov. 15, 2012

(54) Taco frying apparatus that presses and shapes multiple tortillas into a "V" shape form that can be dipped into a standard home deep fryer.

(76) Inventors: Randy Richard Webb, Abilene, TX (US); Rodney Nathaniel Webb, Bellflower, CA (US)

(21) Appl. No.: 13/103,700

(22) Filed: May 9, 2011

(51) Int. Cl. A23P 1/10

(52) U.S. Cl. 99/439

(57) ABSTRACT

The multiple taco shaping and frying apparatus allows for five to ten tortillas to be pressed and formed into the perfect “V” shaped form and submerged into a standard home use deep fryer or pot.

### CROSS-REFERENCE TO RELATED APPLICATION

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention pertains to an apparatus that will be used in the field of cooking. More specifically, the present invention is a cooking apparatus that will shape, mold, and support food while being applied to a heat source.

### BRIEF SUMMARY OF THE INVENTION

The present invention is a device that will shape and form five to ten tortillas into the perfect taco or “V” shaped form for submersion into a deep fryer. This apparatus is designed for home use and allows a basic user to shape and fry up ten taco shells at one time in a standard deep fryer.

### BRIEF DESCRIPTION OF THE DRAWINGS

FIG. 1 is a perspective view of the taco shaping and frying apparatus.

FIG. 2A depicts a side view of an additional attachment to add five additional taco shells.

FIG. 2B depicts a side view of the present invention in FIG. 1

FIG. 3A is a perspective view of the attachment of FIG. 2A.

FIG. 3B is a perspective view of the taco frying apparatus of the present invention.

FIG. 4 is a perspective view of the device in an open position.

FIG. 5 is a perspective view of the taco frying apparatus inside a deep fryer.

FIG. 6 is a perspective view of the attachment in FIG. 2A/3A connected to the taco frying apparatus in FIG. 1.

### DETAILED DESCRIPTION OF THE INVENTION

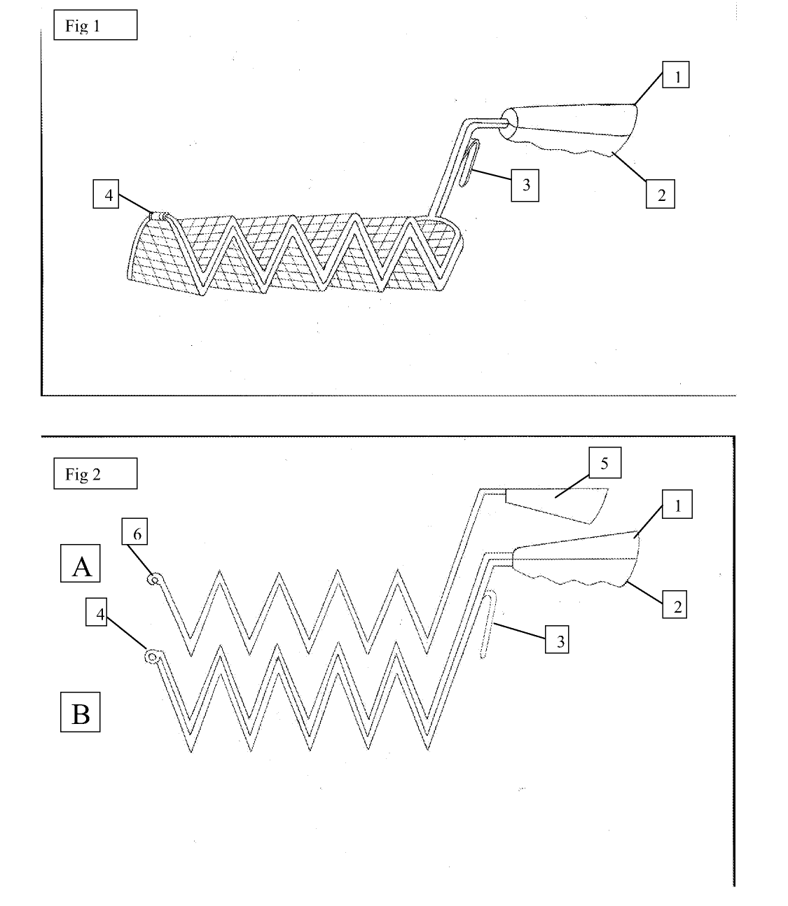

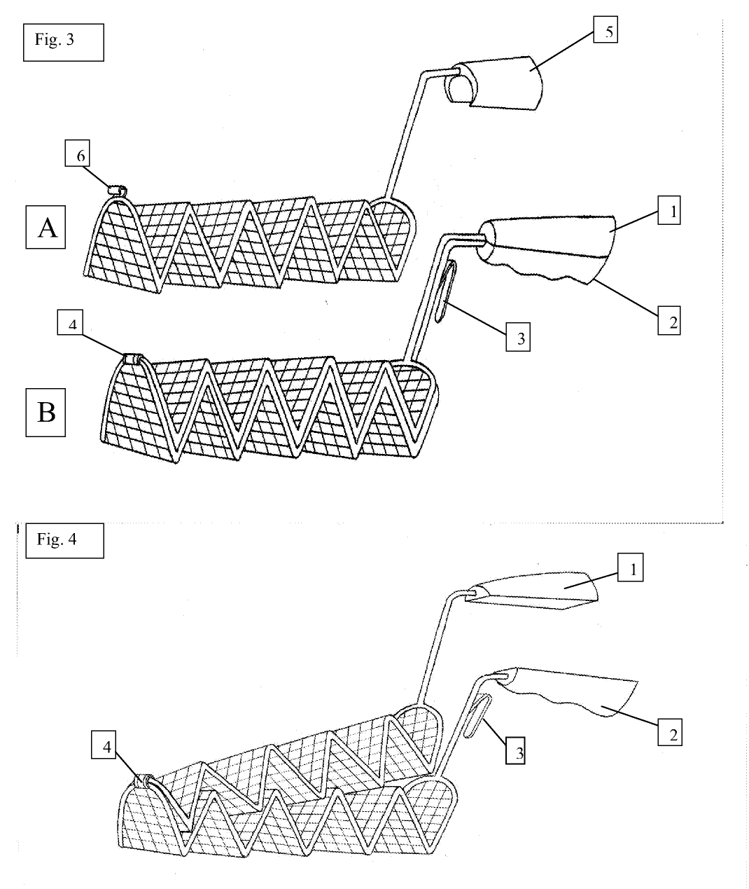

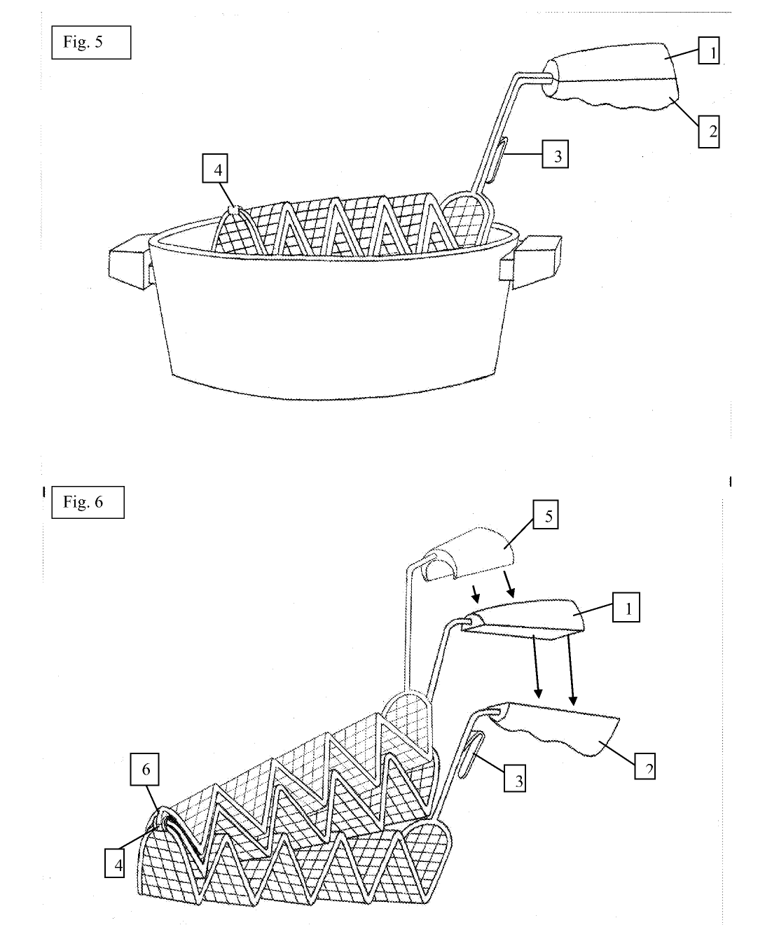

Referring now to the invention in more detail, in FIG. 1 the apparatus is shown as a zigzag pattern making up five “V” shaped patterns that measure approximately 4.5 inches in height, 7 inches in length and 7 inches in depth. These dimensions allow for the taco frying apparatus to fit in a standard home use deep fryer. As seen in FIG. 1, the present invention has two zigzag pieces that make up five “V” shaped spaces composed of stainless steel with a mesh type design to allow the tortillas to be applied directly to the frying oil. In FIG. 1, the present invention is opened up by separating handle 1 from handle 2 with 4 acting as a hinge to keep the two pieces attached together as seen in FIG. 4. After opening these two pieces as seen in FIG. 4, five individual 6″ inch tortillas may be placed in each “V” shaped space and pressed together by connecting handle 1 back together with handle 2 as seen in FIG. 1 to press the five tortillas into a perfect “V” shaped form ready for submersion into the deep fryer as seen in FIG. 5.

In FIG. 2A, there is a side view depiction of the additional attachment that may be used to add five addition tortillas. This attachment shown in FIG. 2A & 3A is used by clamping latch 6 onto hinge 4 and clamping 5 over handle 1 and 2 in the closed position as seen in FIG. 6.

The present invention in FIG. 1 will be composed of stainless or aluminum with the handles being composed of a non-heat conducting plastic. The stainless steel or aluminum will be primarily mesh except along the edges of the invention in where it will be solid steel or aluminum rods to keep the integrity of the “V” shape as seen in FIG. 1.

The advantages of this present invention include its small portability for use in a standard household deep fryer compared to industrial taco makers that are currently utilized in large fast food industries. Another advantage of the present invention is that it is only made of three total moving parts to include the additional attachment.

1. A taco press and frying apparatus that is comprised of two separate zigzag pieces that hold five individual tortillas in between the two pieces to form five perfect “V” shaped tortillas for submersion into a home use deep fryer.

2. The apparatus in claim 1 is compact and made of two mesh stainless steel or aluminum pieces that are held together with a single hinge and two handles that latch together.

3. The apparatus in claim 1 has an addition attachment that is zigzag with the same five “V” shaped spaces that can be latched on top of the original apparatus to fry five additional taco shells.
